(19) United States
(12) Patent Application Publication
(10) Pub. No.: US 2003/0164274 A1
(43) Pub. Date: Sep. 4, 2003

(54) Multi-clutch arrangement

(75) Inventors: Reinhard Feldhaus, Niederwerrn (DE); Markus Heiartz, Wurzburg (DE); Andreas Orlamunder, Schweinfurt (DE); Jochen Kuhstrebe, Biebelried/Westheim (DE); Wolfgang Reisser, Sennfeld (DE); Thomas Wirth, Schwanfeld (DE); Michael Peterseim, Oberdorla (DE); Jurgen Dudenhoffer, Herbstadt (DE); Manfred Zimmer, Zeil (DE); Sebastian Vogt, Bad Neustadt (DE)

Correspondence Address: COHEN, PONTANI, LIEBERMAN & PAVANE, 551 FIFTH AVENUE, SUITE 1210, NEW YORK, NY, 10176, US

(73) Assignee: ZF Sachs AG

(21) Appl. No.: 10/266,112

(22) Filed: Oct. 7, 2002

(30) Foreign Application Priority Data
Oct. 9, 2001 (DE) 101 49 709.1
Aug. 22, 2002 (DE) 102 38 403.7

(51) Int. Cl. F16D 21/02

(52) U.S. Cl. 192/48.8; 192/107 M

(57) ABSTRACT

Multi-clutch arrangement, comprising at least two clutch areas, each with a pressure plate, which can be connected to a housing for rotation in common around an axis of rotation (A) and which can be shifted in the axial direction relative to this housing; with an opposing support; and with a clutch disk, the friction surface arrangement of which can be clamped between the pressure plate and the opposing support. Each of the clutch disks is designed to be connected nonrotatably to a different power takeoff element. A wear-compensating device is assigned to at least one of the clutch areas. In at least one of the clutch areas, the pressure plate is connected to the housing for rotation in common by way of a connecting element arrangement, which, when the clutch area is in the torque-transmitting state, exerts a force on the pressure plate arrangement acting in the direction toward the opposing support.

### BACKGROUND OF THE INVENTION

1. Field of the Invention

The present invention pertains to a multi-clutch arrangement, especially a dual clutch arrangement, comprising at least two clutch areas, each with a pressure plate assembly which is connected to a housing arrangement for rotation in common around an axis of rotation and which can be shifted in the axial direction with respect to this housing arrangement; with an opposing support arrangement; and with a clutch disk arrangement, the friction surface arrangement of which can be clamped between the pressure plate arrangement and the opposing support arrangement, where each of the clutch disk arrangements is designed to be connected nonrotatably to a different power takeoff element.

2. Description of the Related Art

Multi-clutch arrangements, usually designed as dual clutches, are frequently used in trucks together with load-switching transmissions. When a switching operation is carried out, the load is shifted from one of the two clutch areas to the other, which are therefore activated in succession. This switching is carried out in such a way that there is essentially no interruption in the tractive power. This means that, when switching operations are carried out, the various clutch areas are subjected to comparatively severe friction.

### SUMMARY OF THE INVENTION

The task of the present invention is to design a multi-clutch arrangement so that the operation of the clutch suffers essentially no impairment as a result of the frictional stress which occurs during the operation of the clutch.

According to the invention, in at least one of the clutch areas, the area of the pressure plate and/or of the opposing support nearer the friction surface is made of a material with a lower coefficient of thermal expansion; whereas the area farther away from the friction surface is made of a material with a higher coefficient of thermal expansion.

As a result of this design according to the invention, the smaller coefficient of thermal expansion in the area near the friction surface, which usually becomes hotter than the area farther away from the friction surface, ensures that the amount of friction-caused absolute deformation which occurs in the area closer to the friction surface will be approximately the same as that which occurs in the area farther away. The danger that the pressure plate will become deformed and thus form a dome can thus be excluded almost entirely. It is thus also ensured that, even under thermal stress, the frictional interaction will remain uniform over the entire friction surface and thus that these surfaces will wear down uniformly. This also applies to the opposing support arrangement, because it is also subjected to thermal load on one side.

It is possible, for example, for the pressure plate of at least one of the clutch areas or for the opposing support to be made up of several layers, where one layer of material constituting the friction surface of the pressure plate or of the opposing support is made of gray cast iron or particle-reinforced aluminum such as the material known under the trade name “Duralcan”, and where a layer of material farther away from the friction surface is made of aluminum or an aluminum alloy.

In accordance with another aspect of the present invention, a wear-compensating device is assigned to at least one of the clutch areas. The provision of a wear-compensating device of this type has the result that, regardless of the degree to which the friction linings of the clutch disk wear down during operation, especially the elements used to actuate the clutch will always remain in the operating position which they occupied when the clutch was new and not impaired by wear.

It is possible, for example, for the wear-compensating device to comprise: at least one adjusting element, which can be shifted with respect to the pressure plate during the execution of a wear-compensating operation; a first detection element, which is held in a fixed position relative to the housing; a second detection element, which is held in position on the pressure plate arrangement and which, upon the occurrence of wear, can be deflected relative to the pressure plate to cooperate with the first detection element; and an arresting element, by means of which the second detection element can be arrested in its deflected, wear-induced position relative to the pressure plate. Upon the occurrence of wear and the associated deflection of the second detection element, the arresting element can be shifted relative to the pressure plate arrangement and relative to the second detection element. An adjusting movement of the minimum of one adjusting element can be limited by the second detection element and/or by the arresting element. In a design which can be realized very easily, it is also possible and preferable for the second detection element to be designed as a leaf spring and for one end of this spring to be attached to the pressure plate.

To ensure in a simple and reliable manner that the second detection element which has moved after the occurrence of wear remains in its new, wear-induced position, upon the occurrence of wear, at least a certain longitudinal section of the second detection element is moved away from the pressure plate; the arresting element is designed with a wedge-like shape; and the wedge-like arresting element is preloaded by a force which tries to push the element into an intermediate space formed between the pressure plate and the longitudinal section of the second detection element.

In accordance with another advantageous aspect, in a design which can be realized very easily—especially with respect to the total number of individual parts—the minimum of one adjusting element includes an adjusting ring, which, upon the execution of the wear-compensating adjustment, can rotate relative to the pressure plate around the axis of rotation.

So that especially the system areas used for the actuation of the various clutch areas can be designed simply, in at least one of the clutch areas, the pressure plate is connected to the housing for rotation in common by way of a connecting element arrangement, which, when the clutch area is in the torque-transmitting state, generates a force which tries to move the pressure plate toward the opposing support. This design has the result that, because of the contribution to the clutch-engaging force supplied by the connecting element arrangement, the force which the actuating mechanism must provide is reduced. This leads in turn to the result that the loads on the bearings which occur in the actuated state are also reduced. In an embodiment which can be realized very easily and which is preferred for construction reasons, it is possible for the connecting element arrangement to comprise at least one leaf spring element, a first circumferential end of which is connected to the pressure plate, whereas the other circumferential end is connected to the housing, where the second circumferential end is offset with respect to the first circumferential end in the direction toward the opposing support.

To be able to obtain the most uniform possible distribution of the pressing force-reinforcing effect over the circumference, the connecting element arrangement includes a plurality of leaf spring elements, distributed around the circumference. It is also possible for each leaf spring element to comprise at least one leaf spring.

According to another aspect of the present invention, where a wear-compensating device is assigned to at least one of the clutch areas; in the case of at least one of the clutch areas, the pressure plate is connected to the housing for rotation in common by a connecting element arrangement, which, when the clutch area is in the torque-transmitting state, generates a force which tries to move the pressure plate toward the opposing support.

According to a further aspect of the invention, at least one of the pressure plates and/or the opposing support is made of particle-reinforced aluminum and/or at least one of the pressure plates and/or the opposing support comprises at least two disk elements joined together and/or a channel arrangement extends from a radially inner area to a radially outer area in at least one of the pressure plates and/or in the opposing support. As a result, the heating of the previously mentioned clutch components which are subjected to especially severe friction will be as uniform as possible, and the temperature of these same clutch components will be prevented essentially completely from increasing to an excessive degree for a prolonged period of time.

If at least one of the pressure plates and/or the opposing support includes at least two disk elements joined together, an arrangement of recesses can be provided in the surface of at least one of the disk elements, that is, in the surface which is designed to be connected to the other disk element, to form the channel arrangement when the two disk elements are joined. In a case such as this it is possible to provide channel arrangements with a relatively complicated configuration without the need to increase the fabrication work to the same degree as the complexity of the channel arrangements.

In addition, at least one of the disk elements can be made of particle-reinforced aluminum.

The particle-reinforced aluminum, furthermore, can comprise fiber-reinforced aluminum, preferably aluminum which has been reinforced with glass fibers, carbon fibers, or aramid fibers.

The opposing support arrangement, furthermore, can comprise an essentially ring-shaped intermediate plate, where the multi-clutch arrangement is or can be connected to a drive element by way of the intermediate plate to transmit torque.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a partial longitudinal cross section through a first embodiment of a dual clutch according to the invention;

FIG. 2 shows an enlarged, detailed view of a part of the dual clutch shown in FIG. 1;

FIG. 3 shows a partial radial view of the dual clutch shown in FIG. 1, looking radially inward from the outside;

FIG. 4 shows a view, corresponding to FIG. 1, of an alternative embodiment of the dual clutch shown in FIG. 1;

FIG. 5 shows another view, corresponding to FIG. 1, of an alternative embodiment of a dual clutch according to the invention; and

FIGS. 6-8 show the design and functional principles of the wear-compensating device used in the dual clutch according to FIG. 5.

FIG. 9 shows a perspective view of an opposing support made of particle-reinforced aluminum;

FIG. 10 shows a perspective view of a pressure plate made of particle-reinforced aluminum;

FIG. 11 shows a longitudinal cross section of an opposing support comprising two disk elements, joined together;

FIG. 12 shows a longitudinal cross section of a pressure plate comprising two disk elements, joined together;

FIG. 13 shows a longitudinal cross section of an opposing support arrangement, in which a channel arrangement proceeding in the radial direction is provided; and

FIG. 14 shows a perspective view of a pressure plate comprising two disk elements, having an arrangement of recesses which form a channel arrangement when the two disk elements are joined.

### DETAILED DESCRIPTION OF THE PRESENTLY PREFERRED EMBODIMENTS

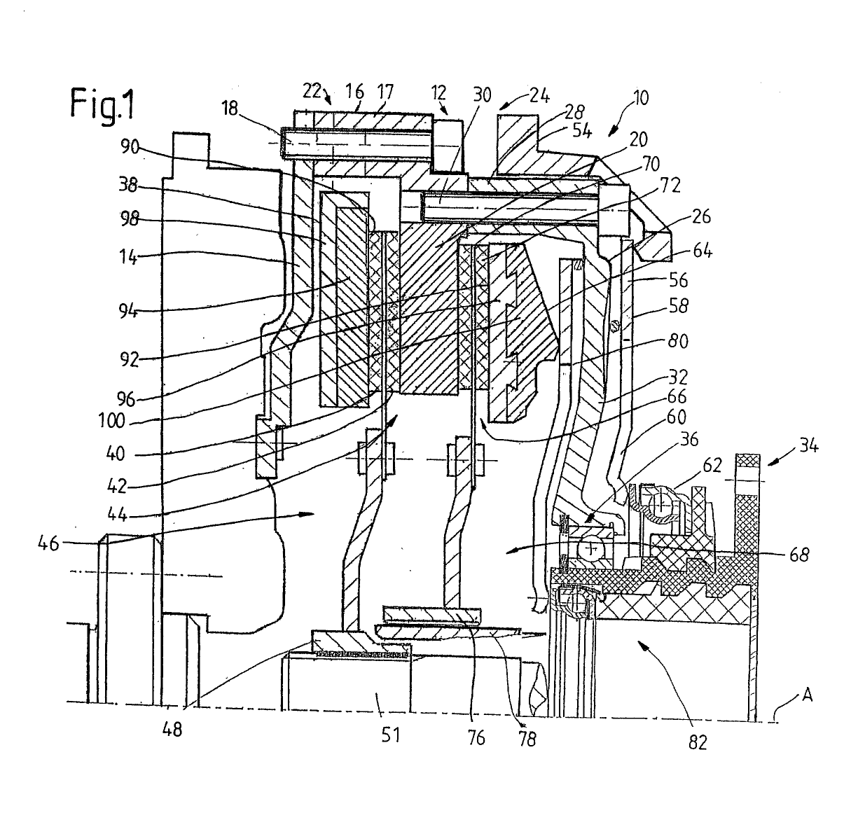

FIGS. 1-3 show a first embodiment of a dual clutch 10 having a housing 12 consisting of several parts. A disk-like part 14, which can be a flywheel, as a secondary mass of a dual-mass flywheel, or as a driver plate, etc., has the job of connecting the dual clutch 10 to a drive shaft, such as a crankshaft of an internal combustion engine, for rotation in common. A radially outer section 17, extending essentially in the axial direction, of a housing part 16 is connected to the disk-like part 14 by a plurality of threaded bolts 18. The radially inward-extending, ring-shaped section 20 of the housing part 16 forms an opposing support area for the two clutch areas 22, 24 of the dual clutch 10, which will be described in greater detail below. Another housing part 26 is rigidly connected by its radially outer section 28, which also extends essentially in the axial direction, to the housing part 16 by a plurality of threaded bolts 30. A radially inward-projecting, ring-shaped section 32 of the housing part 26 serves to support the housing, i.e., to support it with freedom of rotation, on an actuating mechanism 34 by way of a bearing 36.

The first clutch area 22 of the dual clutch 10 comprises a pressure plate 38, which is installed on one axial side of the opposing support area 20, which is attached to the housing 12 or is formed by it. The friction surface arrangement 44, comprising friction linings 40, 42 of a clutch disk 46 of the first clutch area 22, is situated between this pressure plate 38 and the opposing support area 20. In the exemplary embodiment shown, the clutch disk 46 can be designed with a torsional vibration damper. In its radially inner area, the clutch disk 46 is designed to be connected by its hub 48 nonrotatably to a first power takeoff shaft or transmission input shaft 51.

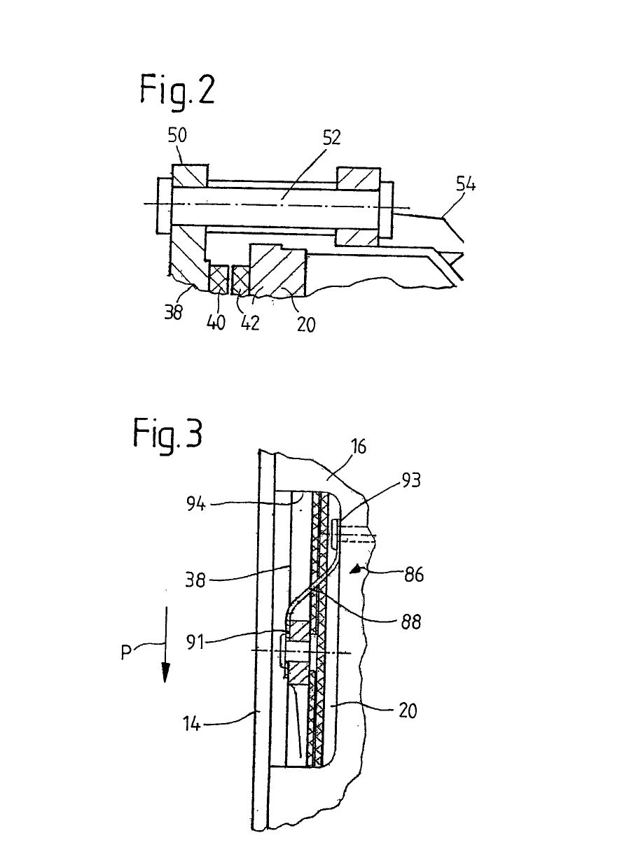

As can be seen in FIG. 2, the pressure plate 38 has radial projections 50 in its radially outer area at several points around the circumference; these projections pass radially through corresponding openings in the housing part 16 with circumferential play. These projections 50 are rigidly connected by tension rods 52 to an actuating element 54 with, for example, a ring-shaped design. The actuating element 54 is acted upon by a radially outer area 56 of an actuating force-transmitting element 58. This element is supported in its radially middle area on the outside of the section 32 of the housing part 26, and in its radially inner area 60 is acted upon by an actuating area 62 of the actuating mechanism 34. The actuating force-transmitting element 58 can be designed as a diaphragm spring, for example, but it can also include a force-transmitting lever arrangement with several lever elements distributed around the circumference.

The second clutch area 24 has a pressure plate 64 on the other axial side of the opposing support area 20. The friction surface arrangement 66, with its friction linings 70, 72, of a clutch disk 68 of the second clutch area 24 is situated between the pressure plate 64 and the opposing support area 20. In the exemplary embodiment shown here, the clutch disk 68 also has a torsional vibration damper 74. In its radially inner area, the clutch disk 68 is designed to be connected nonrotatably via its hub 76 to a second transmission input shaft 78, which is essentially concentric to the first transmission input shaft 51.

An actuating force transmitting element 80 of the second clutch area 24 is supported radially on the outside on the housing part 26 and acts in its radially middle area on the pressure plate 64. Radially on the inside, the actuating force-transmitting element 80 is designed to be acted upon by an actuating area 82 of the actuating mechanism 34. The actuating force-transmitting element 80 can also be designed as a diaphragm spring or as a lever arrangement.

The dual clutch arrangement 10 shown here is of the normally-open type. When, therefore, the two actuating areas 62, 82 of the actuating mechanism 34 act on the various actuating force-transmitting elements 58, 80, a clutch-engaging force is produced, which moves the pressure plates 38, 64 toward the opposing support area 20.

The connection of the pressure plates 38, 64 to the housing arrangement 12 for rotation in common will now be described with reference to FIG. 3 and on the basis of the pressure plate 38 of the first clutch area 22. It is obvious that a similar arrangement of this type can also be provided in the area of the second clutch area 24, and it would be advantageous to do so.

The pressure plate 38 has radial projections 84 at several points around the circumference; these projections can be identical to the radial projections 50, for example, illustrated in FIG. 2. A connecting element arrangement 86 of the first clutch area 22 comprises a plurality of leaf spring elements 88, distributed around the circumference. A first circumferential end area 91 of each of these elements is riveted, for example, to a radial projection 84 of the pressure plate 38, whereas each of the associated second circumferential end areas 93 is attached to the housing part 16 in the area of, for example, the openings 94, through which the radial projections 50 or 84 pass. It can be seen in FIG. 3 that the attachment to the housing part 16 is offset in the direction of the axis of rotation A with respect to the attachment to the pressure plate 38 in the direction toward the opposing support area 20. This results in an arrangement in which the leaf spring elements 88 are curved or cranked in the area between their two end areas 91, 93. By appropriate deformation of the leaf spring elements 88, furthermore, it can also be ensured that they produce the required releasing force for the pressure plate 38, which force acts against the engaging force produced by the actuating area 62.

If the clutch area 22 is in the torque-transmitting state, that is, if the clutch is in the state in which the friction linings 40, 42 are in frictional interaction with the pressure plate 38 and the opposing support area 20, then, as a result of the transmitted torque, the clutch disk 46 exerts a force on the pressure plate 38 acting toward the housing arrangement 12 or housing part 16. After the pressure plate 38 has turned a short distance relative to the housing part 16, the leaf spring elements 88 prevent it from turning any farther. Because of the slanted position of the leaf spring elements 88 in the area between the two end areas 91, 93, however, some of the force acting in the circumferential direction is deflected, and a force acting on the pressure plate 38 in the direction toward the opposing support area 20 is generated. This force increases the pressure with which the pressure plate 38 is pressed against the friction linings 40, 42, so that the transmitted torque, working in cooperation with appropriately designed leaf spring elements 88, produces a self-reinforcing effect. When a dual clutch 10, i.e., the associated clutch areas 22, 24 of the clutch, is being designed for a specific maximum clutch torque, this maximum clutch torque does not have to be generated exclusively by the force exerted by the actuating mechanism 34, and an auxiliary force component can be contributed by the associated leaf spring elements 88. This means that the dimensions of the actuating mechanism 34 can be reduced.

It should be pointed out here that, to achieve the self-reinforcing effect, the connecting element arrangement can be implemented in a wide variety of different ways. Instead of connecting elements in the form of leaf springs subjected to tension, for example, or some other type of elastic elements, it would be possible to provide thrust-actuated lever elements, one end of each lever being supported on the housing arrangement 12, the other end on the associated pressure plate 38, 64, i.e., on a section located axially closer to the opposing support area 20. Associated ramp-like sections of the pressure plate and the housing arrangement which cooperate with each other in the area of, for example, the radial projections 84 could also be used to produce the self-reinforcing effect.

It can be seen especially in FIG. 1 that each of the two pressure plates 38, 64 is made up of two layers. Each of these pressure plates 38, 64 comprises a first layer of material 94, 96, which forms or provides the associated friction surface 90, 92. This first layer 94, 96 is solidly connected to a second layer of material 98, 100. The layers 94, 96 providing the associated friction surfaces 90, 92 are made of a material which has a coefficient of thermal expansion which is lower than that of the material which is used for the layers 98, 100 which are farther away from the friction surfaces. For example, the first layers 94, 96 can be made of gray cast iron or of particle-reinforced aluminum, such as the material known under the trade name “Duralcan”. The second layers can be made of, for example, aluminum or an aluminum alloy. The two material layers can be joined by shrink-fitting and/or adhesive bonding, as shown in the case of pressure plate 38, but a positive, form-locking interconnection can also be used, as shown in the case of the pressure plate 64. The form-locking interconnection can be created by casting or molding one of the layers onto the other. So that the two layers are locked permanently together, dovetail joints, for example, can be provided between them.

The result of this multi-layer design of the pressure plates 38, 64 is that, under the action of heat, during which the material layers 94, 96 closer to the friction surfaces or forming the friction surfaces become hotter than the material layers 98, 100 farther away from the friction surfaces, it is ensured by the different coefficients of thermal expansion that the two material layers undergo approximately the same amount of absolute thermal expansion. It is ensured in this way that the pressure plate 38, 64 will experience essentially no change of shape under severe frictional loads and that in particular no “dome” is formed. This leads in turn to the result that the associated friction linings 40, 42; 70, 72 of the two clutch areas 22, 24 are acted upon uniformly over their entire radial extent and thus also are worn down uniformly. This is especially advantageous for dual clutches 10 or multi-clutches in which, in the absence of any compensation, the slippage always to be expected during the execution of switching operations causes a large amount of thermal stress, which would subject the friction linings to irregular loads and thus to nonuniform wear.

Another advantage of the multi-layer construction is that materials which are especially advantageous for specific sets of requirements can be used for the various layers. For example, a material which has high resistance to wear, is insensitive to grabbing, and has a high coefficient of friction can be used for the first layer 94, 96 of material, whereas a material with good support properties can be used for the second layer 98, 100 of material, which can also have a ribbed structure on the rear surface to improve the heat dissipation. Of course, it is also possible for the pressure plates or for at least one of them to be made up of more than two layers of material. For example, a middle layer could form a support layer, while the front layer provides the friction surface, and the rear layer forms a thermal expansion compensation layer. The same is also true for the opposing support arrangement 20, because it is also subjected to thermal load on one side.

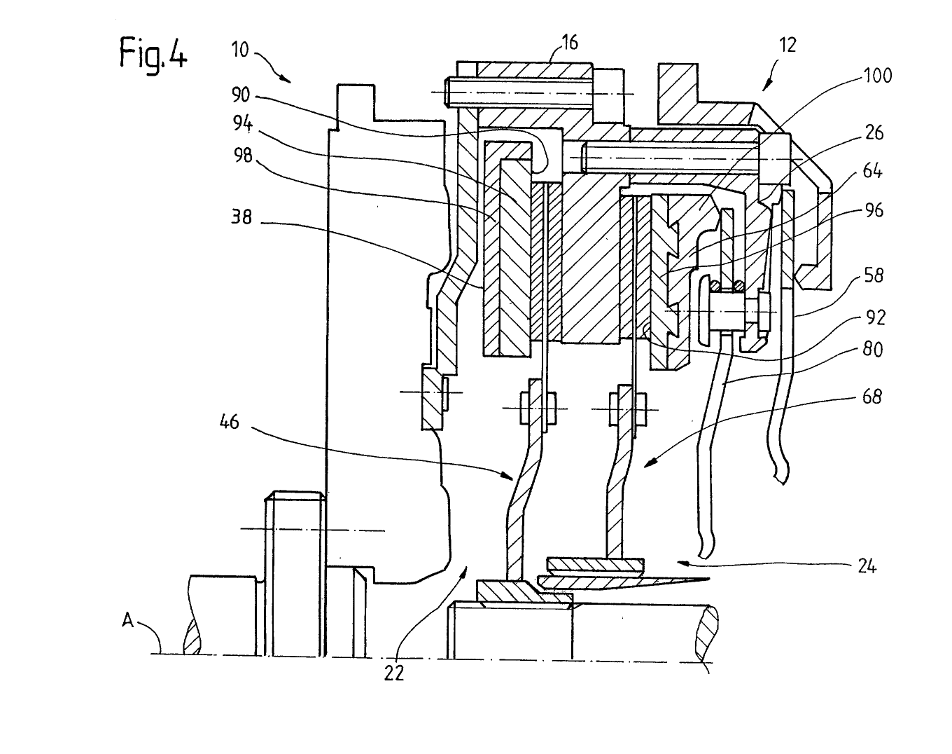

The dual clutch 10 shown in FIG. 4 is essentially the same as the dual clutch 10 shown in FIG. 1 with respect to design and function. It can be seen, however, that clutch areas 22, 24 of the normally-closed type are used here. Here, therefore, stored-energy devices or diaphragm springs 58, 80 can be used to transmit the actuating force. In the example shown, force is exerted on the radially inner end of the spring to execute the clutch-release operation as typical for a clutch of the “push” type. As also in the case of the previously described embodiment of the normally-open clutch, the connecting elements designed as leaf springs can also be used here to provide the releasing force required for the various pressure plates 38, 64.

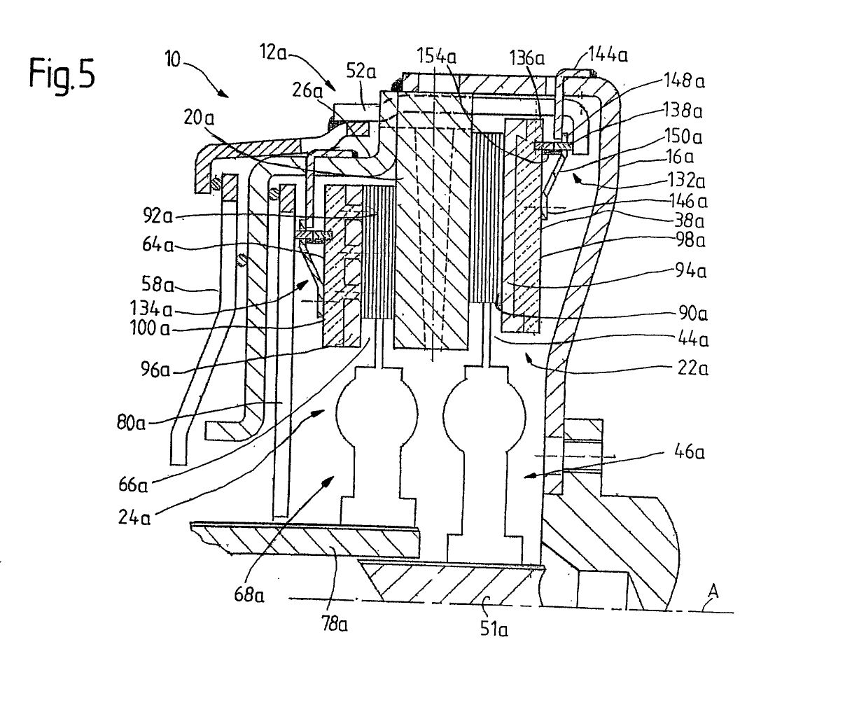

A modified embodiment of a dual clutch according to the invention is shown in FIG. 5. Components which are the same as those previously described with respect to their design or function are designated by the same reference number with the addition of an “a”.

The design and function of the dual clutch shown in FIG. 5 are basically the same as described above. It can be seen in FIG. 5, however, that slight differences are present in the design. For example, the housing part 16 is extended radially toward the inside and thus also ultimately comprises the housing part 14 shown in FIG. 1, via which the connection to the crankshaft can be accomplished. The ring-shaped, disk-like opposing support area 20a is then connected to this housing part 16a by welds, for example. The housing part 26a can also be welded to this assembly, if desired. The actuating element 54a is connected to a plurality of tension rods, visible in FIG. 5, which transmit the actuating force to the pressure plate 38a of the first clutch area 22a.

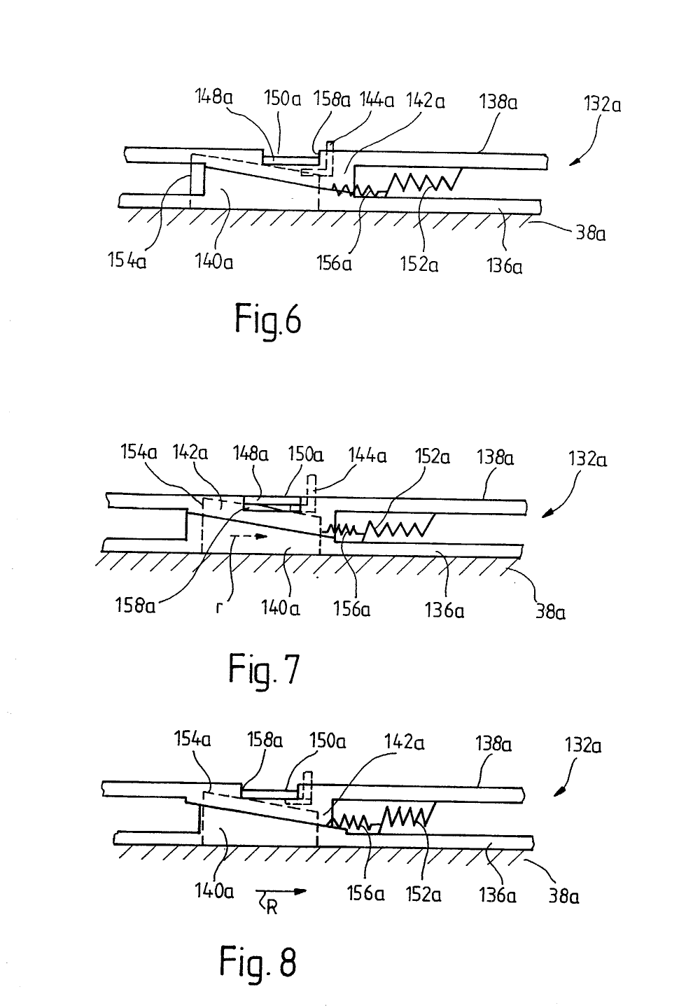

In the dual clutch 10a shown in FIG. 5, a wear-compensating device 132a, 134a is assigned to each of the two clutch areas 22a, 24a. These devices, which are installed in the path of force transmission between the associated actuating force-transmitting elements 58a, 80a and the pressure plates 38a, 64a, ensure that, when the pressure plates 38a, 64a are displaced as a result of wear toward the opposing support area 20a, the various actuating force-transmitting elements can remain in the same, original installation position. The design and function of the two wear-compensating devices 132a, 134a are described below on the basis of the wear-compensating device 132a assigned to the first clutch area 22a and also with reference to FIGS. 6-8. It is obvious that this description is also applicable to the wear-compensating device 134a belonging to the second clutch area 24a.

The wear-compensating device 132a comprises two ring-shaped adjusting elements 136a, 138a. The adjusting ring 136a is supported in the axial direction on the pressure plate 38a, i.e., on the rear surface of this plate. The adjusting ring 136a is concentric to the axis of rotation A and can rotate around the axis of rotation A. On the areas of the rings which rest against each other, the two adjusting rings 136a, 138a have complementary ramps areas 140a, 142a, extending in the circumferential direction. The two adjusting rings 136a, 138a rest against each other in the area of these ramps 140a, 142a. On the side of the adjusting ring 138a facing away from the adjusting ring 136a, the tension rods 52a are supported in the axial direction on the adjusting ring 138a, so that, in the example illustrated here, a clutch-engaging force is transmitted via the adjusting rings 138a and 136a to the pressure plate 38a when an appropriate force is exerted on the actuating force-transmitting elements 58a and a corresponding pulling action is exerted on the tension rods 52a.

A first detection element 144a, designed as an angle piece, is attached to the housing arrangement 12a; in the example illustrated here, it is attached to the housing part 16a. This detection element extends radially inward and ends shortly before the adjusting rings 136a, 138a. One end of a second detection element 150a, namely, the radially inner end 146a, is attached to the pressure plate 38a and extends radially outward from there in an offset manner. The radially outer end 148a of the second detection element 150a extends over the adjusting rings 136a, 138a in the radial direction. As can be seen in FIG. 6, it passes through an opening or notch 158a in the adjusting ring 138a. Because the second detection element 150a is attached to the pressure plate 38a, the adjusting ring 138a is prevented from rotating. The second detection element 150a is designed as, for example, a leaf spring. That is, its radially outer end is pretensioned against the adjusting ring 138a and thus presses this and the adjusting ring 136a against the pressure plate 38a. As can be seen in FIG. 5, and as also indicated schematically in FIG. 6, the two detection elements 144a, 150a overlap in the radially outer area 148a of the second detection element 150a. A movement of the pressure plate 38a, to which the second detection element 150a is attached, toward the opposing support area 20a causes the radially outer area 148a to approach the detection element 144a.

As also indicated schematically in FIG. 6, a pretensioning spring 152a, designed, for example, as a helical tension spring, acts between the two adjusting rings 136a, 138a. As a result of this pretensioning effect, the two adjusting rings 136a, 138a are pretensioned to rotate with respect to each other in a direction, which, through the cooperation of the various pairs of ramps 140a, 142a, results in an increase in the axial dimension of the assembly formed by these two adjusting rings 136a, 138a.

An arresting element 154a, which is designed as a wedge-shaped slider, is also provided. This arresting element 154a is positioned on the inside circumferential side of the adjusting rings 138a, 136a in the area of the second detection element 150a. A pretensioning spring 156a, which is connected via the pretensioning spring 152a, for example, to the adjusting ring 136a, acts on the arresting element 154a in such a way that it forces the wedge-like shape into the space between the pressure plate 38a and the second detection element 150a in the area where this second detection element extends over the adjusting rings 136a, 138a.

The function of the wear-compensating device 132a assigned to the first clutch area 22a will be described below.

Let us assume, for example, that FIG. 6 shows the clutch area 22a in the new, unworn state. In the engaged state of the clutch, the two adjusting rings 136a, 138a are clamped both between the pressure plate 38a and the second detection element 150a and also between the pressure plate 38a and the tension rods 52a, so that it is impossible for relative rotation to occur between them under the pretensioning force of the spring 152a. Even in the released state, in which the powerful force being exerted by way of the tension rods 52a is absent, the elastic pretension produced by the second detection element 150a is still sufficient to prevent this relative rotation.

When now wear occurs in the area of the friction linings of the clutch disk 46a, the pressure plate 38a, together with the adjusting rings 136a, 138a supported on it and the second detection element 150, moves closer to the opposing support area 20a. The two detection elements 144a, 150a come into contact with each other in such a way that the radially outer end 148a of the second detection element 150a is blocked against further axial movement by the detection element 144a and thus, as shown in FIG. 7, is lifted from the adjusting ring 138a. An intermediate axial space is therefore created in the notch 158a between the second detection element 150a and the adjusting ring 138a; this space corresponds essentially to the amount of wear which has occurred. Because the second detection element 150a has now been lifted from the adjusting ring 138a, the pretensioning force of the spring 156a can now draw the wedge-shaped arresting element 154a farther in direction “r” in FIG. 7 into the now enlarged intermediate axial space between the radially outer area 148a of the second detection element 150a and the pressure plate 38a. When the force being exerted via the tension rods 52a is later released upon execution of a clutch-release operation, the force exerted by, for example, the previously described leaf spring elements, which contribute to the production of the clutch-release force, can move the pressure plate 38a in the axial direction away from the opposing support area 20a.

As this is happening, the radially outer area 148a of the second detection element 150a is lifted from the first detection element 144a. Because of the previous circumferential displacement of the arresting element 154a, however, the detection element 150a remains in its wear-induced relative position with respect to the pressure plate 38a and does not initially exert any force on the adjusting ring 138a. Because, therefore, upon execution of a clutch-release operation, both the action of the tension rods 52a and the action of the second detection element 150a are now no longer present, the two adjusting rings 136a, 138a are able to turn with respect to each other under the action of the pretensioning spring 152a, which ultimately means that, while the adjusting ring 138a is held in the circumferential direction by the second detection element 150a, the adjusting ring 136a turns in the direction “R”. During this rotational movement, the pair of ramps 140, 142a slide along each other in the circumferential direction and cause the adjusting ring 138a to move axially away from the pressure plate 38a until it makes contact again with the radially outer end 148a of the second detection element 150a in the area of the bottom of the notch 148a. Once this state is reached, it is no longer possible for any rotation to occur, and the wear-compensating device 132a has again arrived in a stationary condition. In this condition, the increase in the total axial dimension of the two adjusting rings 136a, 138a compensates for the wear to precisely the same degree that the pressure plate 38a moved previously in the axial direction. As clutch-engaging operations continue to be performed, the wear-compensating device 132a is again available for the execution of further wear-compensating adjustments.

In the embodiment described above, therefore, the second detection element 150a serves both to detect the amount of wear in cooperation with the first detection element 144a and to block the adjusting rings 136a, 138a from rotating relative to each other. This blocking action, however, can also be provided by the arresting element 154a. This element can have a radial projection, which engages in a circumferential opening in the adjusting ring 136a with a certain amount of play in the circumferential direction. Depending on the phase of the operation, the arresting element 154a can at first, upon the occurrence of wear, move in the circumferential direction. When a clutch-release operation is performed and there is insufficient force being exerted on the adjusting ring 138a, the adjusting ring 136a can move in the circumferential direction until it strikes the radial projection of the arresting element 154a in the area of the above-mentioned circumferential notch.

It should also be pointed out that, of course, several of these pairs of detection elements, each with its own arresting element, can also be provided at several additional points on the circumference. Basically, however, a single pair of these detection elements is sufficient.

Through the provision of a wear-compensating device, it is ensured that multi-clutches which are subjected to severe frictional stress can offer a uniform clutch characteristic over their entire life-span. Especially in conjunction with pressure plates made up of several layers; it is achieved that, upon the occurrence of wear and the associated compensation adjustment, the entire thickness of the pressure plate layers provided for abrasion can be utilized uniformly over their entire radial dimension.

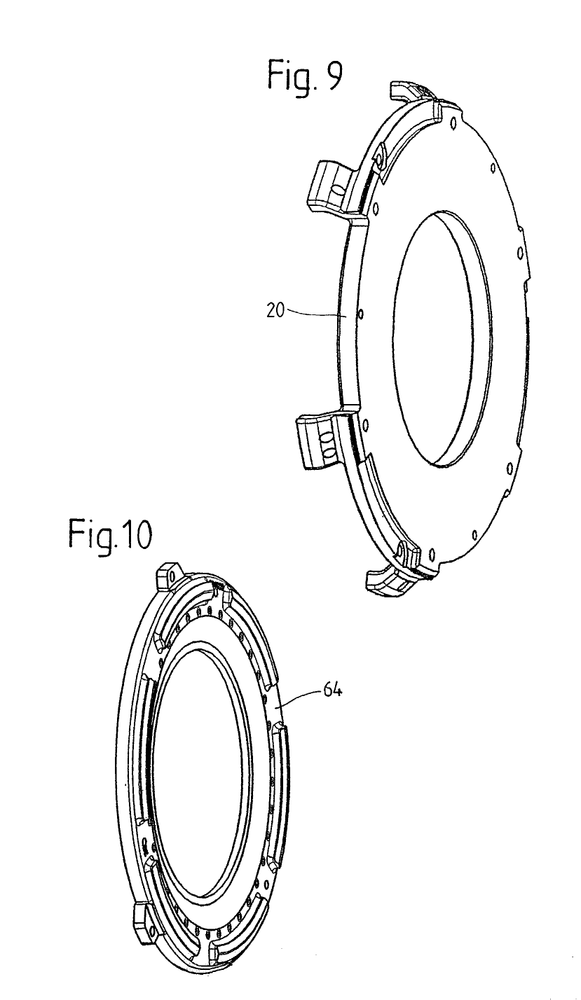

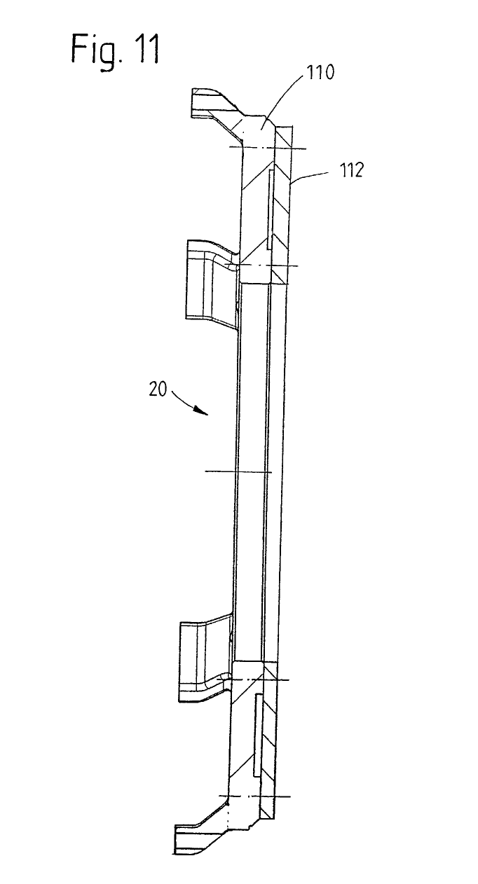

By way of example, furthermore, FIG. 9 shows an opposing support area 20, and FIG. 10 shows a pressure plate arrangement 64, both of which are made of particle-reinforced aluminum. As also in the case of the previously explained multi-part design of these clutch components, designing these clutch components as single parts made of the previously mentioned Duralcan material has the effect of improving the thermal conductivity in comparison with components made of conventional materials such as gray cast iron and thus prevents them from being deformed into a dome shape.

In the case of a dual clutch, the two axial sides of the opposing support area are subjected to different degrees of frictional heat. Especially under such nonuniform load conditions, it is advantageous for the thermal properties of the material used for the opposing support area to promote the uniform heating of the arrangement and thus to eliminate almost completely any deformation of the opposing support area.

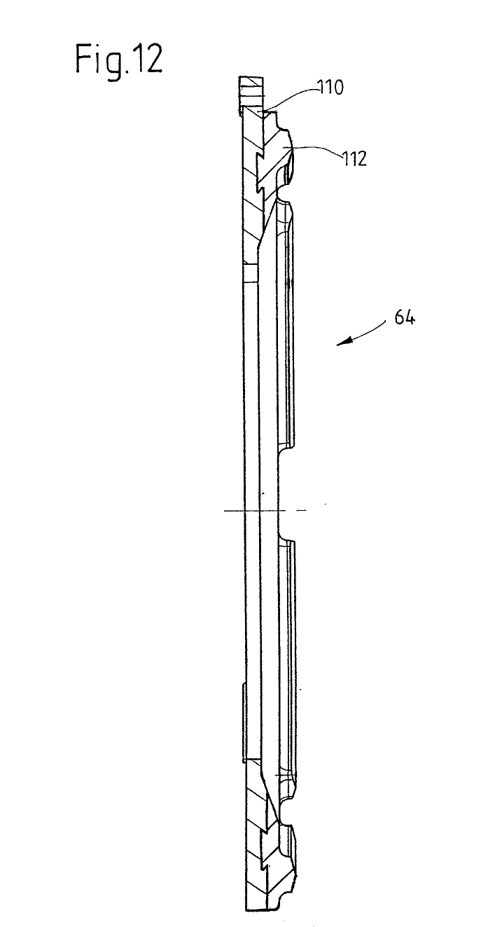

As previously explained in detail, the dome effect in the pressure plate arrangement and in the opposing support area is counteracted by the way in which these components are designed, as illustrated in FIGS. 11 and 12. There the opposing support area 20 and a pressure plate arrangement 64 each comprise two disk elements 110, 112, which are joined together. Preferably at least one of these disk elements 110, 112 is made of particle-reinforced aluminum.

In an alternative embodiment, a channel arrangement in the pressure plate arrangement and/or in the opposing support area, extending from a radially inner area to a radially outer area, almost completely prevents the occurrence of the dome effect in these clutch components.

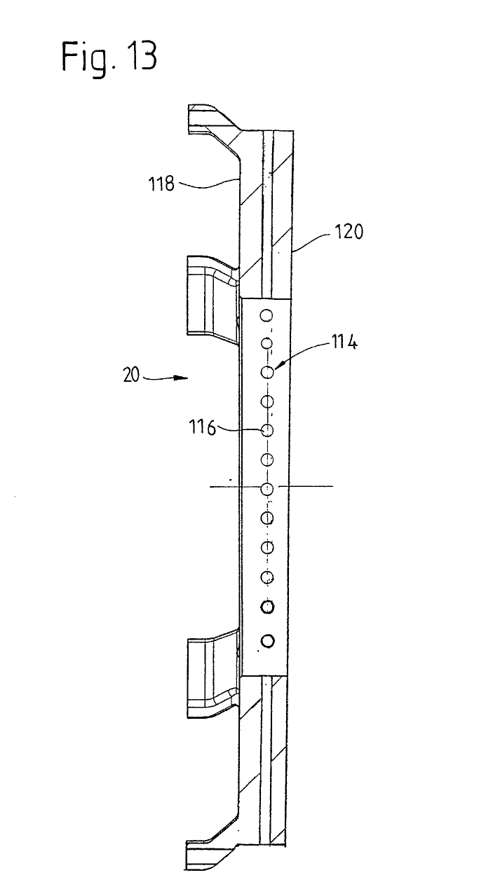

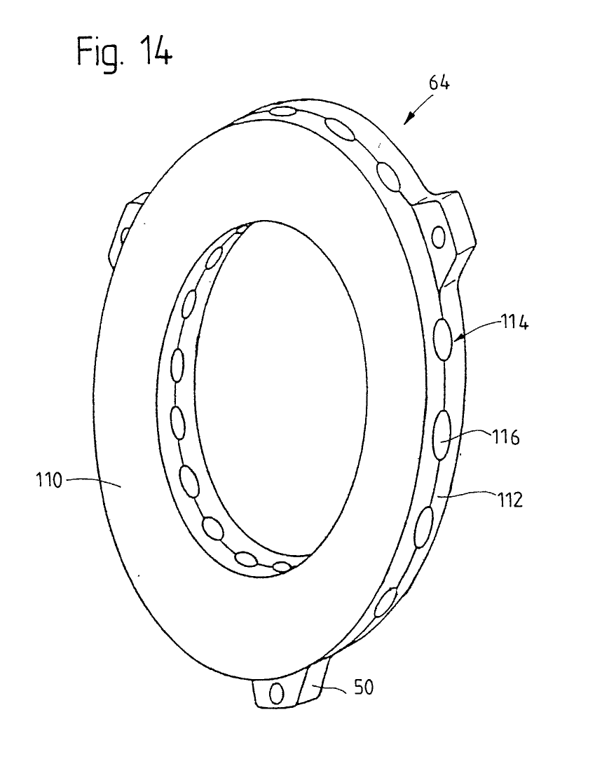

By way of example, FIG. 13 shows an opposing support area 20 with this type of channel arrangement 114, which is located axially in the middle of the frictionally active section, that is, in the area between the two axial sides 118, 120. This channel arrangement 114 comprises a plurality of channels 116, which extend essentially along radii from an inner circumferential surface of the opposing support area 20 to an outer circumferential surface; that is, the channels 116 have an opening on the radially inner side and an opening on the radially outer side. When the opposing support area 20 rotates during the operation of the dual clutch arrangement 10, the air in the channels 116 is conveyed radially outward by centrifugal force, and the suction effect causes fresh air to flow radially from the outside in to take the place of the departing air. The air in the channels 116 contacts a relatively large surface area of the opposing support area 20, and heat is transferred from the opposing support area 20 to the air flowing through the channels 116. It is thus possible reliably to ensure that the heating of the opposing support area 20 does not exceed a certain degree and that the shield effect is prevented almost completely. As can be seen in FIG. 14, a channel arrangement 114 can also be provided in the pressure plate arrangement 64.

For production reasons, it is advantageous for the channels 116 to be straight, because then it is easy to introduce the channels 116 by drilling through a solid opposing support area 20 or pressure plate arrangement 38, 64. Channels 116 with different cross-sectional dimensions can also be provided. It is also possible with this configuration to introduce the channels so that they do not extend exactly along radii but rather along lines which are at an angle to radii while remaining in the plane of the opposing support area 20 or pressure plate 38, 64 which is orthogonal to the axis of rotation A. The angle of inclination can be selected on the basis of the required delivery capacity of the pump arrangement designed in this way. The channels 116 of the channel arrangement 114 can also be designed with any of a wide variety of forms; they could, for example, be in the form of curves or especially in the form of spirals.

Curved channel arrangements 114 cannot be made by drilling or similar processes. Other production methods, however, can be used. For example, lost channel elements can be introduced for a casting operation; these lost channel elements remain in the opposing support area or in the pressure plate arrangement to define the flow paths. It is also possible to introduce fusible mold elements; after the opposing support area and/or the pressure plate arrangement has been cast, these elements are removed by heating them to high temperature, so that the desired channels are left behind.

FIG. 14 also shows that the pressure plate arrangement 64 shown has two disk elements 110, 112. The disk element 112 comprises, for example, the radial projections 50 which are connected to an actuating element 54. The surface area of at least one of the disk elements 110, 112 which faces the other disk is provided with a configuration of recesses, which, when the two disk elements 110, 112 are joined together, are covered by the other disk element 110, 112, so that only the openings of the channels 116 remain, one at the outer circumferential surface, the other at the inner circumferential surface of the disk elements 110, 112. When the two disk elements 110, 12 are produced, therefore, the surface areas which are designed to be joined together can be provided with any desired configuration for the channel arrangement 114 to be obtained. The two disk elements 110, 121 can then be joined together by welding, for example, or by the use of an adhesive, or by brazing. The two disk elements 110, 112 could also be riveted together. The method used to connect the two disk elements 110, 112 together will be determined in addition essentially by the load to which this joint will be subjected during operation.

It should be pointed out that the straight channels 116 which can be seen in FIG. 13 obviously could also be produced by joining two disk elements 110, 112, cast out of, for example, steel. It is also obvious that the pressure plate arrangement 64 shown in FIG. 14 can be integrated into both clutch areas, e.g., into the dual clutch shown in FIG. 1, even if it is formed out of only one ring-shaped disk with the channel arrangement 114 shown.

In addition to the previously cited advantages of the embodiments of the pressure plate arrangement or opposing support area according to the invention, it can also be noted that the weight per unit volume or the mass moment of inertia of the cited clutch components can be significantly reduced when they are made out of aluminum or particle-reinforced aluminum and/or when the described channel arrangement is provided in the clutch components indicated. For example, when Duralcan is used, which has a density of 2.9 kg/mm² versus a conventional gray cast iron material with a density of 7.85 kg/mm³, the mass and thus also the mass moment of inertia can be decreased to one-third.

Because of the smaller mass of the clutch components indicated, finally, it also becomes easier to balance them. This is associated with the fact that, because the functions of at least two clutches are combined into one, multi-clutch arrangements usually have a higher total mass and a higher mass moment of inertia than single clutches. It follows that the large mass and large axial and radial dimensions of a conventional pressure plate arrangement and of a conventional opposing support area make the balancing process very complicated. For this reason, the indicated clutch components, when they are built in the conventional manner, must be balanced dynamically, which requires complicated balancing machines, which are associated with high cost, at least with respect to acquisition and maintenance. As a result of the significant reduction in the mass of the pressure plate arrangement according to the invention or of the opposing support area according to the invention, simpler balancing machines can be used, as a result of which a simplified process can be used and a considerable cost advantage for this work step is obtained. The setup for assembly and the assembly work itself are also simplified. In the case of the multi-clutch arrangements according to the invention, it is possible to eliminate auxiliary assembly devices for hoisting and moving the complete module.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We claim:

1. A multi-clutch arrangement comprising
a housing,
a pair of pressure plates connected to said housing for rotation in common about an axis of rotation and which can be shifted axially with respect to said housing,
an opposing support arranged between said pressure plates, and
a pair of clutch disks having friction surfaces which can clamped between said opposing support and respective said pressure plates, each said clutch disk being connectable nonrotatably to a respective power takeoff element, wherein
at least one of said pressure plates and said opposing support comprises a first material which comes into contact with said friction material and a second material which is axially farther from said friction material than said first material, said first material having a coefficient of thermal expansion which is lower than the coefficient of thermal expansion of said second material.

2. A multi-clutch arrangement as in claim 1 wherein said first material is one of gray cast iron and particle-reinforced aluminum, and said second material is one of aluminum and aluminum alloy.

3. A multi-clutch arrangement as in claim 1 further comprising a wear compensating device fixed to at least one of said pressure plates.

4. A multi-clutch arrangement as in claim 3 wherein said wear-compensating device comprises
at least one adjusting element which can shift position relative to said pressure plate upon execution of a wear-compensating adjustment,
a first detection element which is fixed relative to said housing,
a second detection element which is attached to the pressure plate and can be deflected relative to said pressure plate by cooperation with said first detection element upon occurrence of wear,
an arresting element which can arrest said second detection element in a wear-induced deflection position relative to said pressure plate and which can be shifted relative to the pressure plate and to the first detection element upon the occurrence of wear and deflection of the second detection element, at least one of said arresting element and said second detection element limiting the adjusting movement of the at least one adjusting element.

5. A multi-clutch arrangement as in claim 4 wherein said second detection element comprises a leaf spring having one end attached to said pressure plate.

6. A multi-clutch arrangement as in claim 4 wherein said second detection element has at least one longitudinal section which moves away from the pressure plate upon occurrence of wear, said arresting element being wedge-shaped and being pretensioned to move into an intermediate space formed between the pressure plate and the longitudinal section.

7. A multi-clutch arrangement as in claim 4 wherein said at least one adjusting element comprises an adjusting ring which can rotate about said axis of rotation relative to said pressure plate upon execution of a wear compensating adjustment.

8. A multi-clutch arrangement as in claim 1 further comprising a connecting element arrangement connecting at least one of said pressure plates to the housing, said connecting element arrangement generating an axial force to move said pressure plate toward said opposing support when the clutch disk therebetween is engaged to transmit torque.

9. A multi-clutch arrangement as in claim 8 wherein said connecting element arrangement comprises at least one leaf spring element having a first circumferential end attached to said pressure plate and a second circumferential end attached to said housing, said second circumferential end being offset with respect to said first circumferential end toward said opposing support.

10. A multi-clutch arrangement as in claim 9 wherein said connecting element arrangement comprises a plurality of said leaf spring elements distributed circumferentially about said axis.

11. A multi-clutch arrangement as in claim 9 wherein each said leaf spring element comprises at least one leaf spring.

12. A multi-clutch arrangement comprising
a housing,
a pair of pressure plates connected to said housing for rotation in common about an axis of rotation and which can be shifted axially with respect to said housing,
an opposing support arranged between said pressure plates, and
a pair of clutch disks having friction surfaces which can clamped between said opposing support and respective said pressure plates, each said clutch disk being connectable nonrotatably to a respective power takeoff element,
a wear compensating device fixed to at least one of said pressure plates, and
a connecting element arrangement connecting at least one of said pressure plates to the housing, said connecting element arrangement generating an axial force to move said pressure plate toward said opposing support when the clutch disk therebetween is engaged to transmit torque.

13. A multi-clutch arrangement comprising
a housing,
a pair of pressure plates connected to said housing for rotation in common about an axis of rotation and which can be shifted axially with respect to said housing,
an opposing support arranged between said pressure plates, and
a pair of clutch disks having friction surfaces which can clamped between said opposing support and respective said pressure plates, wherein
at least one of said pressure plates and said opposing support comprising a pair of disk elements joined together.

14. A multi-clutch arrangement as in claim 13 wherein each of said disks is provided with surface recesses which cooperate with surface recesses in the adjoining disk to form radially extending channels in said at least one of said pressure plates and said opposing support to form radially extending channels.

15. A multi-clutch arrangement as in claim 13 wherein at least one of said disk elements is made of particle-reinforced aluminum.

16. A multi-clutch arrangement as in claim 13 wherein said particle-reinforced aluminum comprises fibers consisting of at least one of glass, carbon, and aramid.

17. A multi-clutch arrangement as in claim 1 wherein said opposing support comprises a ring-shaped intermediate plate which can be connected to a drive element for transmission of torque.
